(19) United States
(12) Patent Application Publication
(10) Pub. No.: US 2017/0180508 A1
(43) Pub. Date: Jun. 22, 2017

(54) SYSTEM AND METHOD FOR AUTOMATIC IDENTIFICATION OF REVIEW MATERIAL

(71) Applicant: International Business Machines Corporation, Armonk, NY (US)

(72) Inventors: Priscilla BARREIRA AVEGLIANO, Sao Paulo (BR); Carlos Henrique CARDONHA, Sao Paulo (BR); Rodrigo LAIOLA GUIMARAES, Paraiso (BR); Andrea Britto MATTOS LIMA, Sao Paulo (BR); Julio NOGIMA, Sao Paulo (BR)

(21) Appl. No.: 14/971,559

(22) Filed: Dec. 16, 2015

(51) Int. Cl. H04L 29/08; H04L 12/26; H04L 29/06

(52) U.S. Cl. CPC H04L 67/327; H04L 67/306; H04L 67/42; H04L 43/04

(57) ABSTRACT

An information processing system, a computer readable storage medium, and a method for identifying review material can include collecting assessment data at a server from a plurality of client devices for subject matter in a course, analyzing collectively the assessment data from the plurality of client devices, and based on the analyzing, identifying a deficient subset of topics. The method can further include selecting review material based on the deficient subset of topics identified and sending the review material or a signal representative of the review material to the plurality of client devices which can include presenting the review material to the plurality of client devices. The method can include presenting the review material to each of the plurality of client devices in a format based on a student profile corresponding to each client device in the plurality of client devices.

### BACKGROUND

The present disclosure generally relates to learning systems or network-based education systems and methods, and more particularly relates to a system and method for automatic identification of review material.

The advancement of computer network technologies and client devices has made it possible to deliver educational services that can be tailored to individual students. Existing systems generally objectively recognize whether an individual student has mastered discrete topics and present or direct students to additional learning material based on test results.

### BRIEF SUMMARY

According to one embodiment of the present disclosure, a method for automatic identification of review material includes collecting assessment data at a server from a plurality of client devices for subject matter in a course, analyzing collectively at the server the assessment data from the plurality of client devices, and based on the analyzing, identifying a deficient subset of topics of the subject matter. The method can further include selecting review material based on the deficient subset of topics identified.

In some embodiments, the method further includes the step of sending the review material or a signal representative of the review material to the plurality of client devices which can include presenting the review material to the plurality of client devices. In some embodiments, the method can include presenting the review material to each of the plurality of client devices in a format based on a student profile corresponding to each client device in the plurality of client devices.

In some embodiments, the step of selecting review material further includes limiting the scope or extent of the review material based on restraints of at least one of time, relevance, review material creation cost, review material presentation cost, review material budget, course budget, importance of the deficient subset, or extent of deficiency in performance with respect to the deficient subset. In yet other embodiments the step of selecting review material further includes modifying the scope or extent of the review material based on at least one of a percentage of client devices having the deficient subset of topics, an importance of the deficient subset of topics, an amount of time it takes to review the review material, or a commonality of the deficient subset of topics with other material of the subject matter. In some embodiments, the method initiates the collection of the assessment data upon the instruction from a master client device. Note that in some configurations, the plurality of client devices belong to a plurality of students and the master client device belongs to an instructor of the plurality of students.

In some embodiments, a system for identifying review material includes a server having course materials for a subject matter including review materials for subsets of the topics of the subject matter, an analysis module operatively coupled to the server and configured to receive assessment data from a plurality of client devices used for learning the subject matter and to collectively analyze the assessment data from the plurality of client devices to provide a collective analysis, an identity module operatively coupled to the analysis module and configured to identify at least one deficient subset of topics of the subject matter based on the collective analysis, and a review material assembler operatively coupled to the identify module and configured to generate review material based on the collective analysis.

In some embodiments, the system can include at least one memory and at least one processor communicatively coupled to the at least one memory, the analysis module, the identity module, and the review material module where at least one processor is configured to send the review material or a signal representative of the review material to the plurality of client devices for presentation at the plurality of client devices. In some embodiments, the at least one processor is further configured to limit the scope or extent of the review material based on restraints of at least one of time, relevance, review material creation cost, review material presentation cost, review material budget, course budget, importance of the deficient subset, or extent of deficiency in performance with respect to the deficient subset. In yet other embodiments, the at least one processor is further configured to modify the scope or extent of the review material based on at least one of a percentage of client devices having the deficient subset of topics, an importance of the deficient subset of topics, an amount of time it takes to review the review material, or a commonality of the deficient subset of topics with other material of the subject matter. In some embodiments, the at least one processor is further configured to receive an instruction signal from a master client device to initiate the collection of assessment data from the plurality of client devices. In yet other embodiments, the at least one processor is configure to receive a student profile corresponding to each client device in the plurality of client devices and to send a presentation in a format based on the student profile corresponding to each client device in the plurality of client devices.

In some embodiments, the system includes at least one memory containing computer instructions, and one or more processors communicatively coupled to the at least one memory. The one or more processors when executing the computer instructions can be configured to perform the operations of sending assessment data from a client device to a server for collective analysis of the assessment data on a subject matter in a course from the client device and assessment data from other client devices in a plurality of client devices that identifies at least one deficient subset of topics of the subject matter and receiving from a server review materials for subsets of the topics of the subject matter based on collective analysis, wherein the server identifies at least one deficient subset of topics of the subject matter based on the collective analysis.

In some embodiments, the one or more processors are further configured to receive review material from the server that is limited in scope or extent of the review material based on restraints of at least one of time, relevance, review material creation cost, review material presentation cost, review material budget, course budget, importance of the deficient subset, or extent of deficiency in performance with respect to the deficient subset. In some embodiments, the one or more processors are configured to modify the scope or extent of the review material based on at least one of a percentage of client devices associated with students who did not master a subset of topics or otherwise having the deficient subset of topics, an importance of the deficient subset of topics, an amount of time it takes to review the review material, or a commonality of the deficient subset of topics with other material of the subject matter.

In some embodiments, the one or more processors are configured to present the review material to the client device based on a student profile for the client device while in yet other embodiments, the one or more processors are configured to initiate the collection of the assessment data in response to an instruction from a master client device. The plurality of client devices can belong to students and the master client device can belong to an instructor of the students.

According yet to another embodiment of the present disclosure, a computer readable storage medium comprises computer instructions which, responsive to being executed by one or more processors, cause the one or more processors to perform operations as described in the methods or systems above or elsewhere herein.

### BRIEF DESCRIPTION OF THE SEVERAL VIEWS OF THE DRAWINGS

The accompanying figures, in which like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a depiction of a class room setting illustrating an example of a system for selecting review material according to various embodiments of the present disclosure;

FIG. 2 is a block diagram illustrating an example of the system of FIG. 1;

FIG. 3 is a depiction of the class room setting receiving review materials according to various embodiments of the present disclosure;

FIG. 4 is a block diagram of an information processing system according to various embodiments of the present disclosure; and

FIG. 5 is a flow chart illustrating a method according to various embodiments of the present disclosure.

### DETAILED DESCRIPTION

According to various embodiments of the present disclosure, disclosed is a system and method for identifying review materials. Specifically, according to an example, after an initial learning session and assessment, review material is presented to a group of students to maximize the learning of the group collectively rather than the individual students. Since some students may fail to understand a particular subset of topics presented during a learning session, a particular student's performance and understanding can increase if some or all of the topics that remain unmastered can be presented again in a review session. In a class room setting, in order to compose content for review sessions, teachers or instructors face certain challenges or restraints such as time which limits the number or subsets of topics that can be reviewed in a particular review session. Other challenges include differences in student background or learning styles that lead to scenarios where sets of misunderstood topics may vary from individual to individual. Thus, many of the embodiments further detailed below support the optimal composition or assembly of review materials in review sessions for groups of students. This optimal content selection should take into account various constraints for a particular group of students such as the subset of topics (subtopics) the majority of students in the group had difficulty with.

In various embodiments of the present disclosure, a system or method in a first phase can include an instructor teaching certain content where a group of students do an assessment or answer questions in one or more quizzes which assess whether the students understood the content. Each answer the students provide can indicate which topics they did not understand. The quizzes can provide the system with assessment data automatically (e.g., via tablets, laptops or smartphones). In a second phase, the assessment data can be submitted to a remote server where the assessment data indicates for each student the topics that the student did not understand or master. In some embodiments, the students provide their answers to quizzes and a cloud-based algorithm can identify an optimal subset of review material for review. The review material is then delivered to the students and the instructor. An optimization module can select an optimal subset of topics for review subject to constraints or resource restrictions (e.g., maximizes the number of learned topics of the student who will have learned less after the initial learning session by selecting up to X topics to review), and creates or assembles the review materials to be delivered by the instructor to the students in the classroom. The review materials can include metadata that can be used in selecting the appropriate review materials for the group based on the collective analysis of the assessment data. Other constraints considered include time which can limit the number of subtopics that can be reviewed in a particular review session. Price is another constraint where a budget or cost may be associated with the review of each topic. An optimal set of review materials can be optimized for students and an instructor for in-class review. In some embodiments, the review material is delivered by the instructor in the classroom and may not be suited for a scenario for self-paced learning by students. The various embodiments can generally maximize the overall sum of learned topics for all students.

A discussion of various embodiments of the present disclosure will be provided below illustrating in more detail several examples.

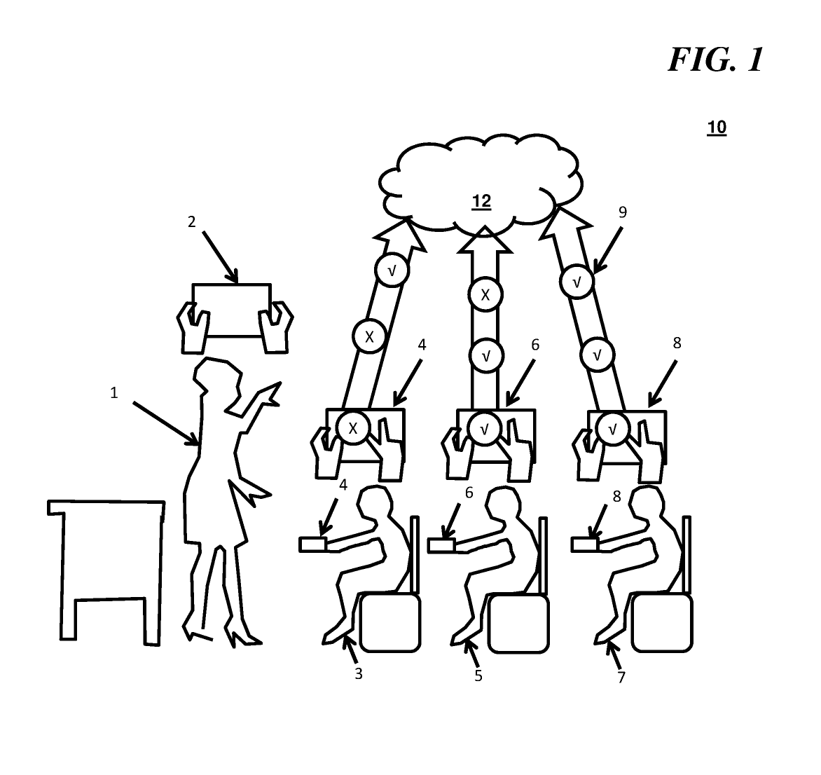

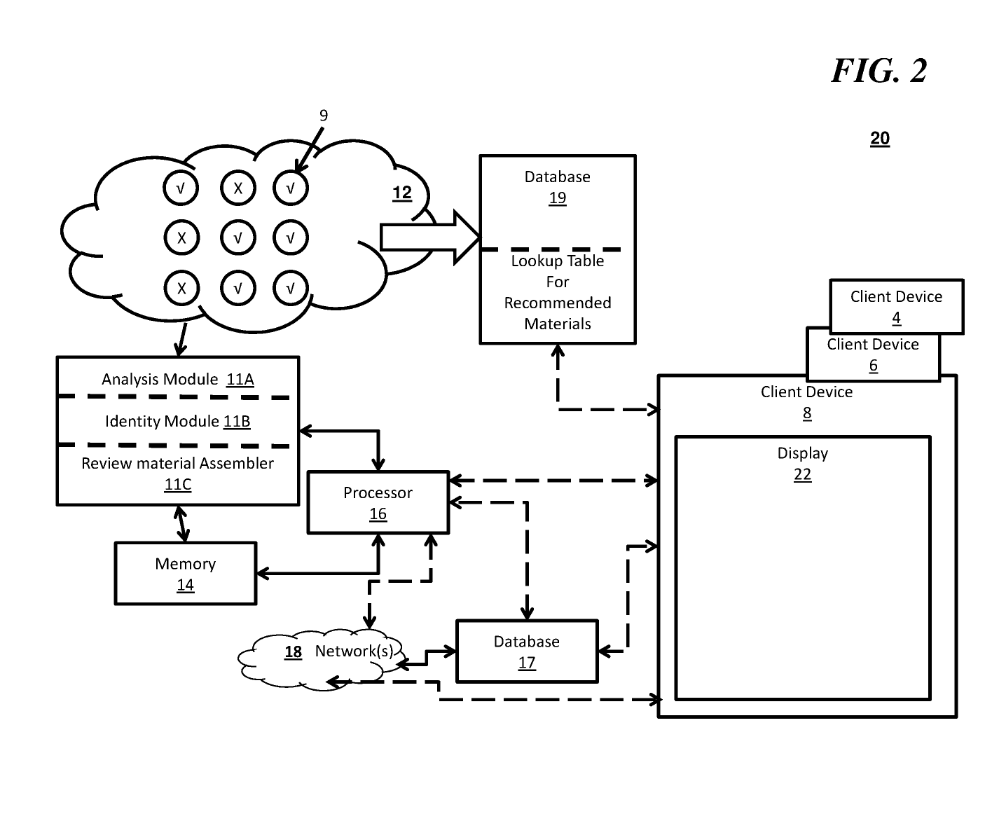

Referring to FIG. 1, a system 10 in accordance with the embodiments provides a method and system for identifying review material includes a cloud based system or a server 12 having course materials for a subject matter including review materials for subsets of the topics of the subject matter. The system 10 can be utilized in a class room setting with an instructor 1 that can have their own instructor client device 2. The instructor 1 can initiate a learning session and provide assessments or quizzes to a group of students 3, 5, and 7 having their own respective client devices 4, 6, and 8. The assessment can include questions and resulting assessment data 9 that assesses the mastery of the topics or subset of topics (subtopics) for each of the students 3, 5, and 7. The assessment data can be collected or gathered at the server 12. Referring to FIG. 2, once the assessment data 12 is collected at the server 12, an analysis module 11A operatively coupled to the server 12 is configured to receive assessment data 9 from a plurality of client devices 4, 6, 8, and collectively analyzes the assessment data 9 from the plurality of client devices to provide a collective analysis. An identity module 11B operatively coupled to the analysis module 11A then identifies at least one deficient subset of topics of the subject matter based on the collective analysis, and a review material assembler 11C operatively coupled to the identify module 11B assembles or retrieves review material based on the collective analysis. The review materials can be stored in any number of locations and the processing or handling of the review materials can be done via a processor 16 if not done by the analysis module 11A, identity module 11B, and review material assembler 11C. Alternatively, the processor 16 can operate cooperatively with the other modules or memories. For example, the review materials can be stored in the server or cloud 12 or at a memory 14 or at any number of local or remote databases 17 or 19. The access to the database 17 can be provided through one or more networks 18 (which can be wired or wireless). Database 19 can include a lookup table for recommended review materials which could include pointers for the particular review materials based on the assessment data 9. In some embodiments, the review materials can already be stored within the client devices and such materials can be protected with digital rights management mechanisms.

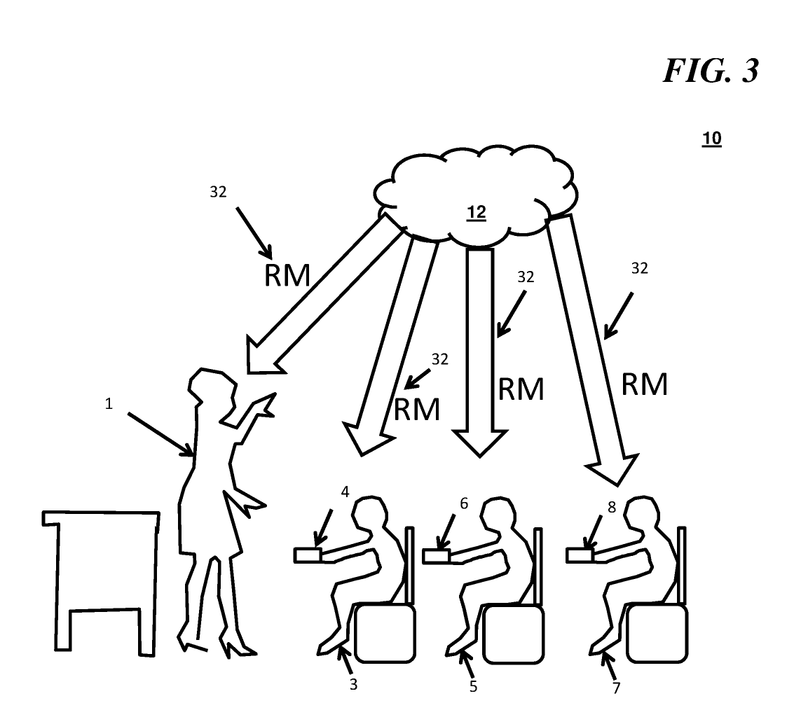

Referring to FIG. 3, a depiction of the system 10 is shown where the review material 32 is already assembled and in the process of being sent from the server 12 to the client devices 4, 6, and 8 for the respective students 3, 5, and 7. The review material can be automatically sent to the students upon receipt and analysis of the assessment data or the system can be configured to require the teacher 1 and her client device to queue up the delivery of the review materials.

In some embodiments, the system 20 as shown in FIG. 2 can include at least one memory 14 and at least one processor 16 communicatively coupled to the at least one memory 14, an analysis module 11A, an identity module 11B, and an review material assembler 11C where the at least one processor 16 sends the review material or a signal representative of the review material to the plurality of client devices for presentation at the plurality of client devices. In some embodiments, the at least one processor 16 is further configured to limit the scope or extent of the review material based on restraints of at least one of time, relevance, review material creation cost, review material presentation cost, review material budget, course budget, importance of the deficient subset, or extent of deficiency in performance with respect to the deficient subset. In yet other embodiments, the at least one processor 16 is further configured to modify the scope or extent of the review material based on at least one of a percentage of client devices having the deficient subset of topics, an importance of the deficient subset of topics, an amount of time it takes to review the review material, or a commonality of the deficient subset of topics with other material of the subject matter. In some embodiments, the at least one processor 16 is further configured to receive an instruction signal from a master client device to initiate the collection of assessment data from the plurality of client devices 4, 6, and 8. In yet other embodiments, the at least one processor 16 is configured to receive a student profile corresponding to each client device in the plurality of client devices and to send a presentation in a format based on the student profile corresponding to each client device in the plurality of client devices. The profile can include, for example, the preferred or best learning styles for the particular student or group of students which can go into the decision of the format for the review materials being presented.

In some embodiments, a training session (for an overall topic) can include a plurality of sub-topic “learning objects” which can include metadata to enable the system to appropriately select and assemble the learning materials. After the training session is completed by a group of students, each student is evaluated for which sub-topics were understood, on the one hand, and which were not understood and should be reviewed, on the other hand. The collective students in the group are evaluated as a group to minimize the number of subtopics misunderstood by each student in a group of students.

When assembling a review session, in some embodiments, the automated training system uses overall time and cost limits (constraints) for the entire review session to try to fit in one or more sub-topics “learning objects” that the students need review on. In one example, a group has students A, B, and C, and has a learning training session with five sub-topics. Student A understood all sub-topics of the learning training session. Student B misunderstood only one subtopic, e.g., subtopic 2 of 5, and Student C misunderstood two subtopics, e.g., subtopics 3 of 5 and 4 of 5. The automated training system will try to fit into a review session, based on an overall time and cost constraint for the review session, the following subtopics in a particular order that would maximize the learning by the group as a whole. In one example scenario, either subtopics 3 of 5 or 4 of 5 (which hopefully will bring up Student C's understanding of total subtopics) is prioritized to be inserted into a review session as a first subtopic. Then, according to the example, the other one of subtopics 3 of 5 or 4 of 5, if it also fits into the review session limited by total time and cost constraints, is inserted into the review session. Finally subtopic 2 of 5, if it additionally fits in the review session limited by total time and cost constraints, is inserted into the review session. The aforementioned approach tries to fit subtopics into a review session, which may be limited in overall time allotted and/or overall cost allotted, to maximize the lowest student overall score for understanding subtopics. This is only one example of an overall group optimization of a review session and the embodiments are not limited to such example.

As another example, in the second step of optimization of the review session described above, the insertion of sub-topic 2 of 5 into the review session may be prioritized over the insertion of the other one of subtopics 3 of 5 or 4 of 5. That is, after the first step of optimization of a review session, and with expectation that after a first subtopic is covered in the review session Student B would understand the reviewed one of subtopics 3 of 5 or 4 of 5, then both Student B and Student C would have understanding of an equal total number of subtopics, i.e., four out of five of the sub-topics. Therefore, a second subtopic inserted into the review session may be subtopic 2 of 5, and then a third subtopic inserted would be the other one of subtopics 3 of 5 or 4 of 5. Certainly other considerations can be made in maximizing the overall group learning and thus causing a different ordering in the presentation of review materials. Maximizing the overall group learning can also be considered a possible selection criteria for selection of topics or subtopics for review in some examples. In another example, a minimum mastery level from each of client devices among the plurality of client devices associated with the students can also be used as possible selection criteria for selection of topics or subtopics for review.

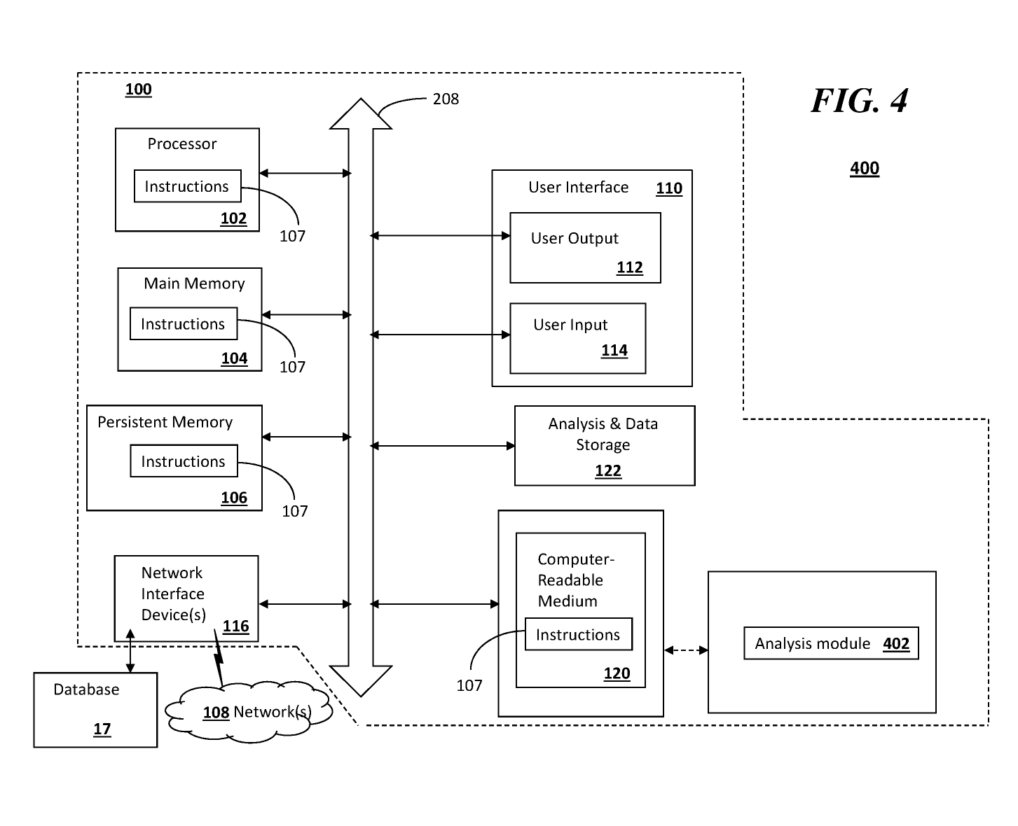

As shown in FIG. 4, an information processing system 100 of a system 400 can be communicatively coupled with the analysis module 402 and a group of client devices of FIGS. 1-3. According to this example, at least one processor 102, responsive to executing instructions 107, performs operations to communicate with the analysis module 12 via a bus architecture 208, as shown. The at least one processor 102 is communicatively coupled with main memory 104, persistent memory 106, and a computer readable medium 120. The processor 102 is communicatively coupled with an Analysis & Data Storage 122 that, according to various implementations, can maintain stored information used by, for example, the analysis module 12 and more generally used by the information processing system 100. Optionally, for example, this stored information can include information received from the client devices 2, 4, and 6 of FIGS. 1-3. For example, this stored information can be received periodically from the client devices 2, 4, and 6 and updated over time in the Analysis & Data Storage 122. That is, according to various example implementations, a history log of the information received over time from the client devices 2, 4, and 6 (or others) can be stored in the Analysis & Data Storage 122. Additionally, according to another example, an history log of review materials for one or more students can be maintained stored in the Analysis & Data Storage 122. The analysis module 402, and the information processing system 100, can use the information from the history log such as in the analysis process and in making recommendations for review materials to be sent collectively to the group of students.

The computer readable medium 120, according to the present example, can be communicatively coupled with a reader/writer device (not shown) that is communicatively coupled via the bus architecture 208 with the processor 102. The instructions 107, which can include instructions, configuration parameters, and data, may be stored in the computer readable medium 120, the main memory 104, the persistent memory 106, and in the processor's internal memory such as cache memory and registers, as shown.

The information processing system 100 includes a user interface 110 that comprises a user output interface 112 and user input interface 114. Examples of elements of the user output interface 112 can include a display, a speaker, one or more indicator lights, one or more transducers that generate audible indicators, and a haptic signal generator. Examples of elements of the user input interface 114 can include a keyboard, a keypad, a mouse, a track pad, a touch pad, a microphone that receives audio signals. The received audio signals, for example, can be converted to electronic digital representation and stored in memory, and optionally can be used with voice recognition software executed by the processor 102 to receive user input data and commands.

A network interface device 116 is communicatively coupled with the processor 102 and provides a communication interface for the information processing system 100 to communicate via one or more networks 108. The networks can include wired and wireless networks, and can be any of local area networks, wide area networks, or a combination of such networks. For example, wide area networks including the internet and the web can inter-communicate the information processing system 100 with other one or more information processing systems that may be locally, or remotely, located relative to the information processing system 100. It should be noted that mobile communications devices, such as mobile phones, Smart phones, tablet computers, lap top computers, and the like, which are capable of at least one of wired and/or wireless communication, are also examples of information processing systems within the scope of the present disclosure. The network interface device 116 can provide a communication interface for the information processing system 100 to access the database 17 according to various embodiments of the disclosure.

The instructions 107, according to the present example, can include instructions for monitoring, instructions for analyzing, instructions for retrieving and sending information and related configuration parameters and data. It should be noted that any portion of the instructions 107 can be stored in a centralized information processing system or can be stored in a distributed information processing system, i.e., with portions of the system distributed and communicatively coupled together over one or more communication links or networks.

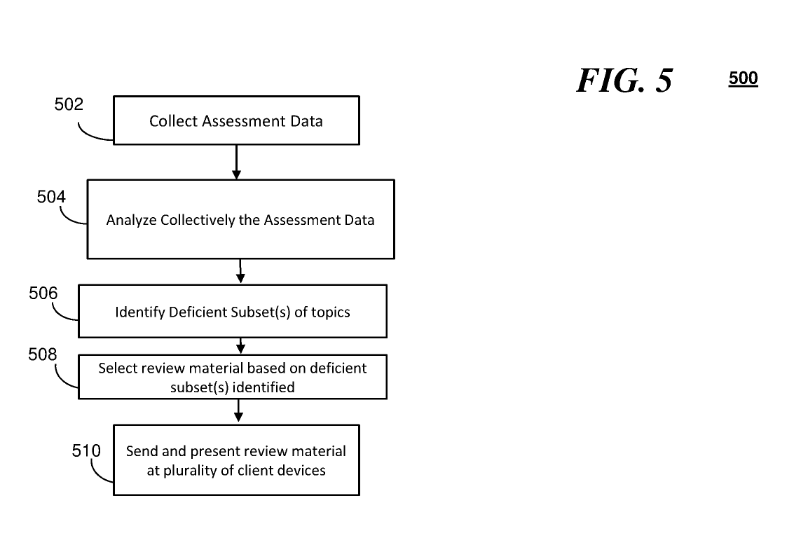

FIG. 5 illustrates an example of a method according to various embodiments of the present disclosure that operate in conjunction with the information processing system of FIG. 4. Specifically, according to an example shown in FIG. 5, a method 500 of identification of review material includes collecting at step 502 assessment data at a server from a plurality of client devices for subject matter in a course, analyzing collectively at step 504 at the server the assessment data from the plurality of client devices, and based on the analyzing, identifying at step 506, a deficient subset of topics of the subject matter. The method can further include selecting at step 508 review material based on the deficient subset of topics identified. In some embodiments, the method 500 further includes the step 510 of sending the review material or a signal representative of the review material to the plurality of client devices which can include presenting the review material to the plurality of client devices. In some embodiments, the method can include presenting the review material to each of the plurality of client devices in a format based on a student profile corresponding to each client device in the plurality of client devices.

In some embodiments, the step of selecting review material further includes limiting the scope or extent of the review material based on restraints of at least one of time, relevance, review material creation cost, review material presentation cost, review material budget, course budget, importance of the deficient subset, or extent of deficiency in performance with respect to the deficient subset. In yet other embodiments the step of selecting review material further includes modifying the scope or extent of the review material based on at least one of a percentage of client devices associated with students who did not master a subset of topics or otherwise having the deficient subset of topics, an importance of the deficient subset of topics, an amount of time it takes to review the review material, or a commonality of the deficient subset of topics with other material of the subject matter. In some embodiments, the method initiates the collection of the assessment data upon the instruction from a master client device. Note that in some configurations, the plurality of client devices belong to a plurality of students and the master client device belongs to an instructor of the plurality of students.

### Non-Limiting Examples

The present invention may be a system, a method, and/or a computer program product. The computer program product may include a computer readable storage medium (or media) having computer readable program instructions thereon for causing a processor to carry out aspects of the present invention.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer readable program instructions described herein can be downloaded to respective computing/processing devices from a computer readable storage medium or to an external computer or external storage device via a network or networks, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems), and computer program products according to embodiments of the invention. It will be understood that each block of the flowchart illustrations and/or block functional diagrams, and combinations of blocks in the flowchart illustrations and/or block functional diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or functional block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the computer readable storage medium is shown in an example embodiment to be a single medium, the term “computer readable storage medium” should be taken to include a single medium or multiple media (e.g., a centralized or distributed database, and/or associated caches and servers) that store the one or more sets of instructions. The term “computer-readable storage medium” shall also be taken to include any non-transitory medium that is capable of storing or encoding a set of instructions for execution by the machine and that cause the machine to perform any one or more of the methods of the subject disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a computer-readable storage medium, as listed herein and including art-recognized equivalents and successor media, in which the software implementations herein are stored.

Although the present specification may describe components and functions implemented in the embodiments with reference to particular standards and protocols, the disclosure is not limited to such standards and protocols. Each of the standards represents examples of the state of the art. Such standards are from time-to-time superseded by faster or more efficient equivalents having essentially the same functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. The examples herein are intended to cover any and all adaptations or variations of various embodiments. Combinations of the above embodiments, and other embodiments not specifically described herein, are contemplated herein.

The Abstract is provided with the understanding that it is not intended be used to interpret or limit the scope or meaning of the claims. In addition, in the foregoing Detailed Description, various features are grouped together in a single example embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Although only one processor is illustrated for an information processing system, information processing systems with multiple CPUs or processors can be used equally effectively. Various embodiments of the present disclosure can further incorporate interfaces that each includes separate, fully programmed microprocessors that are used to off-load processing from the processor. An operating system (not shown) included in main memory for the information processing system may be a suitable multitasking and/or multiprocessing operating system, such as, but not limited to, any of the Linux, UNIX, Windows, and Windows Server based operating systems. Various embodiments of the present disclosure are able to use any other suitable operating system. Various embodiments of the present disclosure utilize architectures, such as an object oriented framework mechanism, that allows instructions of the components of operating system (not shown) to be executed on any processor located within the information processing system. Various embodiments of the present disclosure are able to be adapted to work with any data communications connections including present day analog and/or digital techniques or via a future networking mechanism.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The terms “communicatively coupled” or “communicatively coupling” include, but are not limited to, communicating electronic control signals by which one element may direct or control another. The term “configured to” describes hardware, software or a combination of hardware and software that is adapted to, set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. Any suitably configured processing system is similarly able to be used by embodiments herein, for example and not for limitation, a personal computer, a laptop personal computer (laptop PC), a tablet computer, a smart phone, a mobile phone, a wireless communication device, a personal digital assistant, a workstation, and the like. A processing system may include one or more processing systems or processors. A processing system can be realized in a centralized fashion in one processing system or in a distributed fashion where different elements are spread across several interconnected processing systems.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

What is claimed is:

1. A method comprising
collecting assessment data at a server from a plurality of client devices for subject matter in a course;
analyzing collectively at the server the assessment data from the plurality of client devices;
based on the analyzing, identifying a deficient subset of topics of the subject matter; and
selecting review material based on the deficient subset of topics identified.

2. The method of claim 1, further comprising the step of sending the review material or a signal representative of the review material to the plurality of client devices.

3. The method of claim 1, wherein the step of selecting review material further comprises limiting a scope or extent of the review material based on restraints of at least one of time, relevance, review material creation cost, review material presentation cost, review material budget, course budget, importance of the deficient subset, or extent of deficiency in performance with respect to the deficient subset.

4. The method of claim 1, wherein the step of selecting review material further comprises modifying a scope or extent of the review material based on at least one of a percentage of client devices having the deficient subset of topics, an importance of the deficient subset of topics, an amount of time it takes to review the review material, or a commonality of the deficient subset of topics with other material of the subject matter.

5. The method of claim 1, further comprising the step of presenting the review material to the plurality of client devices.

6. The method of claim 1, further comprising initiating the collection of the assessment data upon instruction from a master client device.

7. The method of claim 1, wherein the step of selecting review material comprises at least one of maximizing a collective mastering of the subject matter by the plurality of client devices or a minimum mastery level from each of the client devices among the plurality of client devices, wherein the plurality of clients devices are associate with a corresponding plurality of students.

8. The method of claim 1, further comprising presenting the review material to each of the plurality of client devices in a format based on a student profile corresponding to each client device in the plurality of client devices.

9. A system comprising:
a server having course materials for a subject matter including review materials for subsets of topics of the subject matter;
an analysis module operatively coupled to the server and configured to receive assessment data from a plurality of client devices used for learning the subject matter and to collectively analyze the assessment data from the plurality of client devices to provide a collective analysis;
an identity module operatively coupled to the analysis module and configured to identify at least one deficient subset of topics of the subject matter based on the collective analysis; and
a review material assembler operatively coupled to the identify module and configured to generate review material based on the collective analysis.

10. The system of claim 9, further comprising at least one memory and at least one processor communicatively coupled to the at least one memory, the analysis module, the identity module, and the review material assembler, the at least one processor configured to perform operations comprising:
sending the review material or a signal representative of the review material to the plurality of client devices for presentation at the plurality of client devices.

11. The system of claim 10, the at least one processor further configured to limit a scope or extent of the review material based on restraints of at least one of time, relevance, review material creation cost, review material presentation cost, review material budget, course budget, importance of the deficient subset, or extent of deficiency in performance with respect to the deficient subset.

12. The system of claim 10, the at least one processor further configured to modify a scope or extent of the review material based on at least one of a percentage of client devices having the deficient subset of topics, an importance of the deficient subset of topics, an amount of time it takes to review the review material, or a commonality of the deficient subset of topics with other material of the subject matter.

13. The system of claim 10, the at least one processor further configured to receive an instruction signal from a master client device to initiate collection of assessment data from the plurality of client devices.

14. The system of claim 10, the at least one processor further configured to receive a student profile corresponding to each client device in the plurality of client devices and to send a presentation in a format based on the student profile corresponding to each client device in the plurality of client devices.

15. A system comprising:
at least one memory containing computer instructions;
one or more processors communicatively coupled to the at least one memory, the one or more processors, responsive to executing the computer instructions, configured to perform operations comprising:
sending assessment data from a client device to a server for collective analysis of the assessment data on a subject matter in a course from the client device and assessment data from other client devices in a plurality of client devices that identifies at least one deficient subset of topics of the subject matter; and
receiving from a server review materials for subsets of the topics of the subject matter based on collective analysis, wherein the server identifies at least one deficient subset of topics of the subject matter based on the collective analysis.

16. The system of claim 15, the one or more processors being configured to receive review material from the server that is limited in scope or extent of the review material based on restraints of at least one of time, relevance, review material creation cost, review material presentation cost, review material budget, course budget, importance of the deficient subset, or extent of deficiency in performance with respect to the deficient subset.

17. The system of claim 15, the one or more processors being configured to modify a scope or extent of the review material based on at least one of a percentage of client devices having the deficient subset of topics, an importance of the deficient subset of topics, an amount of time it takes to review the review material, or a commonality of the deficient subset of topics with other material of the subject matter.

18. The system of claim 15, the one or more processors being configured to present the review material to the client device based on a student profile for the client device.

19. The system of claim 15, wherein the one or more processors are configured to initiate the collection of the assessment data in response to an instruction from a master client device.

20. The system of claim 19, wherein the plurality of client devices belong to a plurality of students and the master client device belongs to an instructor of the plurality of students.
